(19) United States
(12) Patent Application Publication
(10) Pub. No.: US 2017/0103189 A1
(43) Pub. Date: Apr. 13, 2017

(54) METHOD OF DETERMINING TREATMENTS FOR MULTIPLE CONCURRENT PATIENT DIAGNOSES

(71) Applicant: Mary Cott, Cumberland, ME (US)

(72) Inventor: Mary Cott, Cumberland, ME (US)

(21) Appl. No.: 15/271,428

(22) Filed: Sep. 21, 2016

Related U.S. Application Data
(60) Provisional application No. 62/238,927, filed on Oct. 8, 2015.

(51) Int. Cl. G06F 19/00

(52) U.S. Cl. CPC G06F 19/363; G06F 19/345; G06F 19/325; G06F 19/3406

(57) ABSTRACT

A method for determining treatment plans for patients having one or more diagnoses, including multiple concurrent diagnoses. The method provides functionality to complete an OASIS and transforms the assessment into a treatment plan for one or more diagnoses for a patient.

### BACKGROUND INFORMATION

Field of the Invention

The invention relates to methods for determining healthcare plans, more particularly to methods for determining healthcare plans in home health care regimens.

Discussion of Prior Art

The Outcome and Assessment Information Set (OASIS) is information required by Medicare-certified home health agencies to assess a home health patient's clinical and functional status during admission. The results of the OASIS assessment provide the basis for generating a plan of care to be provided to the patient by healthcare practitioners, i.e., a nurse, physical therapist, occupational therapist, speech therapist, medical social worker and/or home health aide.

Conventional tools to assist home health practitioners with the OASIS merely provide a ‘form filler’ functionality that only allows the provider to fill in the OASIS form on a computer and print the output.

It is not uncommon that a patient will be diagnosed to have multiple concurrent illnesses but, after completion of the OASIS form, the practitioner must still mentally determine a patient's problem list and develop a treatment plan that may encompass up to 150 different and potentially unstable conditions. This antiquated method creates the opportunity for the practitioner to overlook problem conditions, omit a treatment in the treatment plan, or include a treatment that is not indicated by the assessment. Conventional products lack any ability to analyze the content of the form, provide error checking, or provide analysis to identify a comprehensive, coordinated plan of care.

What is needed, therefore, is a method for transforming the OASIS data into a comprehensive care plan containing treatments for multiple concurrent diagnoses.

### BRIEF SUMMARY OF THE INVENTION

The invention is a method for developing a comprehensive patient care plan based on an OASIS clinical assessment, particularly the information captured in the OASIS form from Chapter 2, OASIS-10 C1, ICD-10, SOC that is prepared and distributed by the Centers for Medicare & Medicaid Services. A user interface is provided that presents the practitioner with the list of OASIS questions, and prompts the practitioner to enter the answers to the questions according to the OASIS specifications. Once the OASIS has been completed, software analysis transforms the disjointed information and original data into a set of care plans that are suitable to address the needs of the patient, even in the likely event that the OASIS reveals multiple concurrent diagnoses.

A database is provided to store the original data gathered by the OASIS and allow for storage of predefined care plans that are suitable to address all diagnoses that may be recognized from the answers in the OASIS questionnaire.

To generate the set of care plans that are required for a particular patient, software is provided that analyzes the OASIS data to identify abnormal clinical and functional conditions. After identifying one or more abnormal conditions, the software analyzes the severity of the condition and, depending on the severity, analyzes additional key factors to determine the proper care plan for a particular condition, and then adds that care plan to the set of care plans for the patient. All pertinent OASIS data is analyzed for abnormal findings, and these steps are repeated for each abnormal condition. The result is a set of care plans that are designed to address each diagnosis found in the OASIS.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 illustrates the software system that is provided to implement the method.

FIG. 2 shows a segment of the activity table in the database.

FIG. 3 is a sample care plan in the database.

FIG. 4 is a flow chart showing the top level steps in the method according to the invention.

FIG. 5 is a flow chart showing the steps in determining which care plans to present to the care giver.

FIG. 6 is a table showing an example of critical OASIS questions.

FIG. 7 is an example of the multiple types of care plans that could result from one abnormal condition depending on the additional factors that are analyzed.

FIG. 8 is an example OASIS question and answer set for frailty.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

The method according to the invention is a method for developing a comprehensive patient care plan based on a patient assessment form, such as, for example, the OASIS. The disclosure describes the method in terms of its use by a healthcare practitioner, or simply practitioner, and it is understood that the term practitioner encompasses personnel specifically trained to provide healthcare, such as, for example, a nurse, physical therapist, occupational therapist, speech therapist, medical social worker and/or home health aide. Furthermore, OASIS is referred to throughout this disclosure as the patient assessment form, but it is understood that the method according to the invention is not limited to creating patient-specific care plans based on OASIS, but may also be applied to other assessment forms.

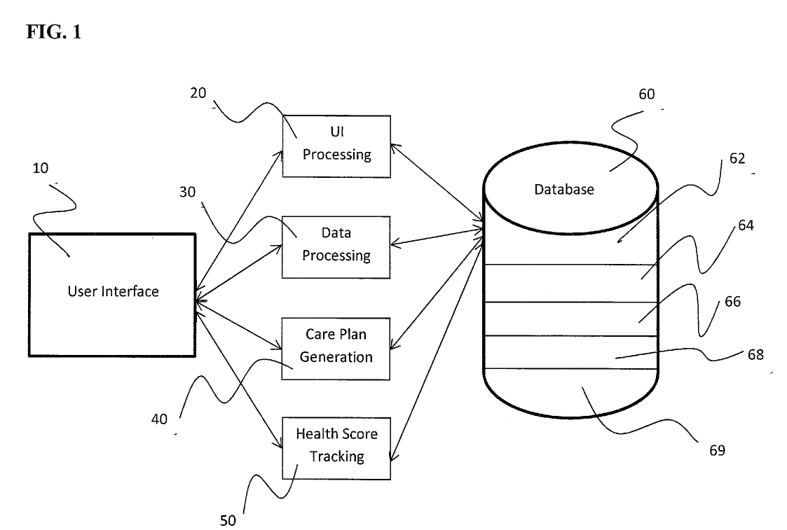

FIG. 1 illustrates software that is provided that includes a user interface 10 for a practitioner to use in completing an electronic version of the OASIS home healthcare assessment form, processes to process data 20, 30, and generate care plans 40, track and score the overall health of the patient 50, and a database 60. The user interface 10 prompts the practitioner to input the necessary clinical assessment of the patient into an electronic OASIS form. The software then analyzes the OASIS data and provides the practitioner with the ability to store the data in the database, generate a viewable set of proper care plans based on the entered data, and track the overall health of the patient.

The electronic OASIS form is derived from the clinical assessment form that is distributed by the Centers for Medicare & Medicaid Services, and may be coded into the user interface 10 or, alternatively, the OASIS questions may be stored in the database 60 and made accessible to the user through the user interface process 20.

In the embodiment shown, the database contains an assessment table 62, a pathway table 64, a care plan table 66, a patient ID table 68 and an activity table 69. The patient ID table 68 receives and stores all of the patients identifying information such as name, birthdate and address. The assessment table 62 receives and contains the OASIS information that is entered by the practitioner. The care plan table 66 contains a set of predefined care plans that contains at least one plan for each condition that may need to be addressed based on the OASIS data. The predefined care plans are created based on the best practices known to the home health industry. The pathway table 64 is used by the software to store calculated and manipulated information that is used in generating the set of care plans. The conditions that result in care plans that are selected for a particular patient are stored in the activity table 69 along with the associated data (i.e., severity of the condition).

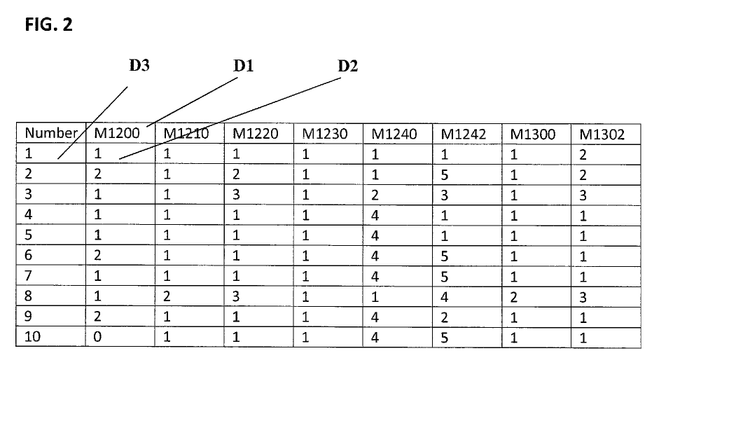

FIG. 2 illustrates a standard structure for the activity table 69, showing the data entered for a total of eight different OASIS questions, with each question represented by its OASIS identification number (ID) D1. The first row contains the IDs D1 for each question. The following rows contain the answers D2 for each of the corresponding questions D1s. Each row represents a separate patient visit. The first column indicates the number of the visit D3. For example, in the OASIS guide, M1200 corresponds to: “Vision (with corrective lenses if the patient usually wears them): 0—Normal vision, sees adequately in most situations and can see medication labels and read newsprint; 1—Partially impaired, cannot see medication labels but can see obstacles in path and surrounding layout and can count fingers at arm's length; 2—Severely impaired, cannot locate objects without hearing or touching them, or patient is nonresponsive.” In this example, D1 illustrates the field name abbreviated M1200, which corresponds to the OASIS question for vision, and D2 is the entry for the M1200 at the first visit, in this case indicating that the patient's vision is partially impaired. Additional columns would be added for each question that generated an abnormal finding.

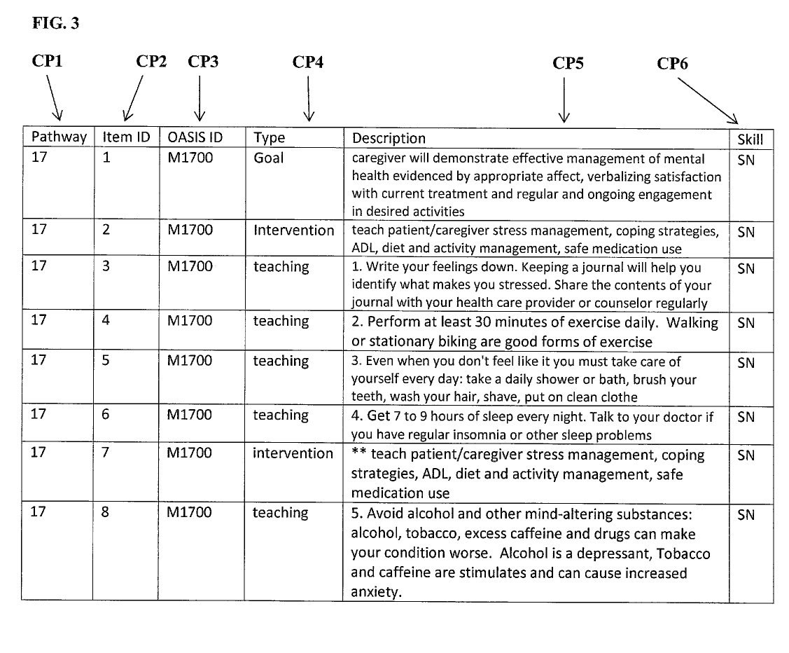

FIG. 3 is an example of a care plan, in particular the care plan for OASIS ID M1700, which is directed to cognitive functioning. Each care plan includes one or more items, which may be a goal, an intervention, or a teaching. The first column CP1 contains the pathway number that the software uses to access the care plan. CP2 contains the item number, which starts at 1 for each care plan. The second column CP3 contains the OASIS ID, which is the same for each item in an individual care plan. The third column CP4 contains a description of the type of item, for example, a goal describes the preferred result from administration of the care plan, an intervention is an affirmative course of action, and a teaching is an item that it is hoped the patient learns in order to be more self-sufficient. The fourth column CP5 contains the action that forms the basis of the care plan. The fifth column CP6 contains the level of skill that the practitioner must have in order to complete the item, in this case “SN” which represents “skilled nursing”. At least one care plan is included for each OASIS ID. In the current example, one care plan that includes 8 items, including 1 goal, 2 interventions and 5 teachings, is provided for M1700. This care plan is added to the set of care plans that is presented to the practitioner if an abnormal clinical and functional finding is entered for M1700.

In completing the initial OASIS, the practitioner must answer approximately 80 different questions about the patient's clinical and functional health status. These questions fall into two groups: 1) patient background and contextual information, including such things as date of the assessment, date of referral, and skill set of the practitioner completing the assessment; 2) factors that relate directly to the patient's current medical condition. In the current OASIS, approximately 66 of the roughly 80 questions relate directly to the patient's present medical condition and result in the addition of a specific care plan if an abnormal condition is found.

Each question relating to the patient's medical condition has a range of answers, in which the practitioner determines the clinical assessment based on the severity of a condition or status. If the practitioner answers “0” to a question, the status is stable and no treatment recommendations are generated. If the practitioner documents an answer greater than “0”, thereby identifying an unstable condition and indicating the level of severity of the condition, a nursing and therapeutic treatment recommendation is generated. After all of the OASIS indicators are answered, the software compiles all the clinical assessments with values greater than “0”. If a patient has an abnormal OASIS finding, the assessment software extracts the appropriate treatment plan from a database.

The set of conditions indicating an abnormal condition and all associated data is stored in the activity table 69 and the recommended treatment plans are then compiled into a viewable format for presentation to the practitioner for reference in developing an overall patient care plan, based on the OASIS data. During the initial visit all of the OASIS questions must be answered and the data input into the software. For each subsequent visit the software will retrieve the information stored in the activity table 69, and only the questions related to the conditions stored in the activity table must be answered. If on a subsequent visit a certain condition has improved and an abnormal condition is no longer indicated, that entry is removed from the activity table 69 and the condition no longer addressed during subsequent visits.

After the OASIS data is entered, the software assesses the practitioner's inputs to identify and display the abnormal clinical and functional findings for the patient. Based on the indication of abnormal clinical and functional findings, the software generates industry-standard recommendations for treatment of abnormal findings in the home healthcare setting, ensuring that the practitioner's care plan is developed according to appropriate standards of care. The software also assesses the patients overall condition and presents this to the practitioner in the form of a score that provides the practitioner with an indication of the patient's overall health and also allows the practitioner to easily track whether the patient's overall health is improving over time.

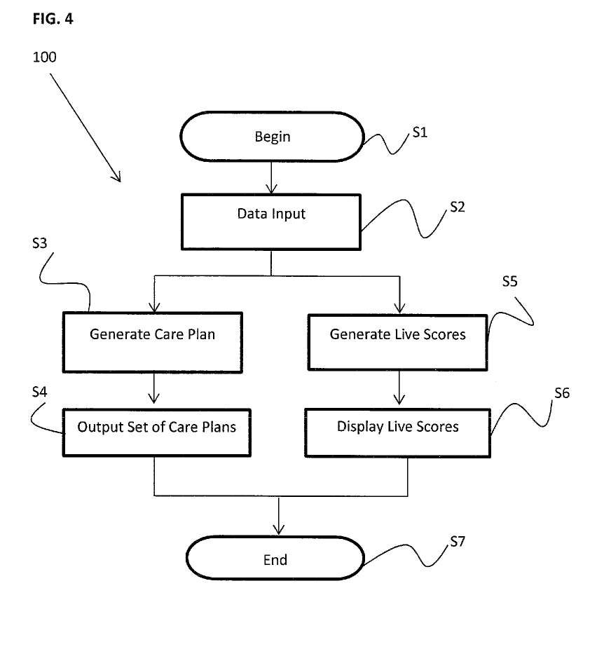

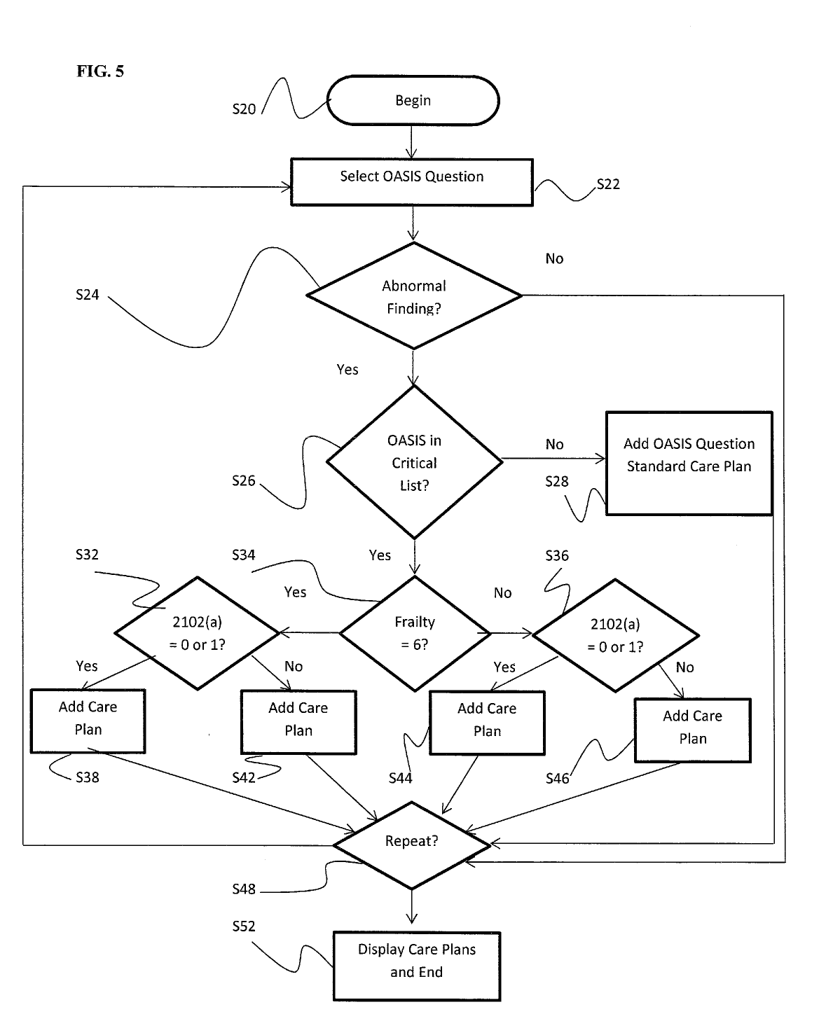

FIG. 4 illustrates the first embodiment of the method 100. At the first step S1, the software is activated and a user interface is initialized that contains the OASIS questions. The second step S2 prompts a practitioner to enter data into the user interface. Once the questionnaire is completed, the practitioner selects a “generate care plan” option presented in the user interface. The generate care plan step S3 first saves the data entered in S2 to the assessment table 62 in the database 60, and then analyzes the data to identify abnormal conditions that require a care plan, as shown in FIG. 5. The set of care plans are then displayed to the practitioner at step S4.

At step S5 the software generates a score that indicates the patient's overall health, which is then displayed to the practitioner S6. As explained above, each of the OASIS questions that relate to the patient's medical condition has a number of potential answers, ranging in value from 0 to 5, with 0 indicating no abnormal finding and the values 1 through 5 indicating an abnormal condition, the increasing value of the number indicating a greater level of severity of the condition. As the software iterates over the OASIS data, it averages the values to obtain the score, organized into subcategories, and then averages the subcategory scores to display a single score to the practitioner that represents a general overall assessment of the patient's health.

FIG. 5 illustrates the method of selecting the appropriate set of care plans. To select this set of plans, the software iterates over the entire set of OASIS data that relates to the patient's current medical condition. For each condition, the software checks to see if an abnormal finding is indicated at step S24. If there is no abnormal finding the method goes on to the next OASIS ID number and repeats the first step until the end of the list is reached at step S48. If there is an abnormal finding, the method checks at step S26 to see if the OASIS ID is a part of the critical list.

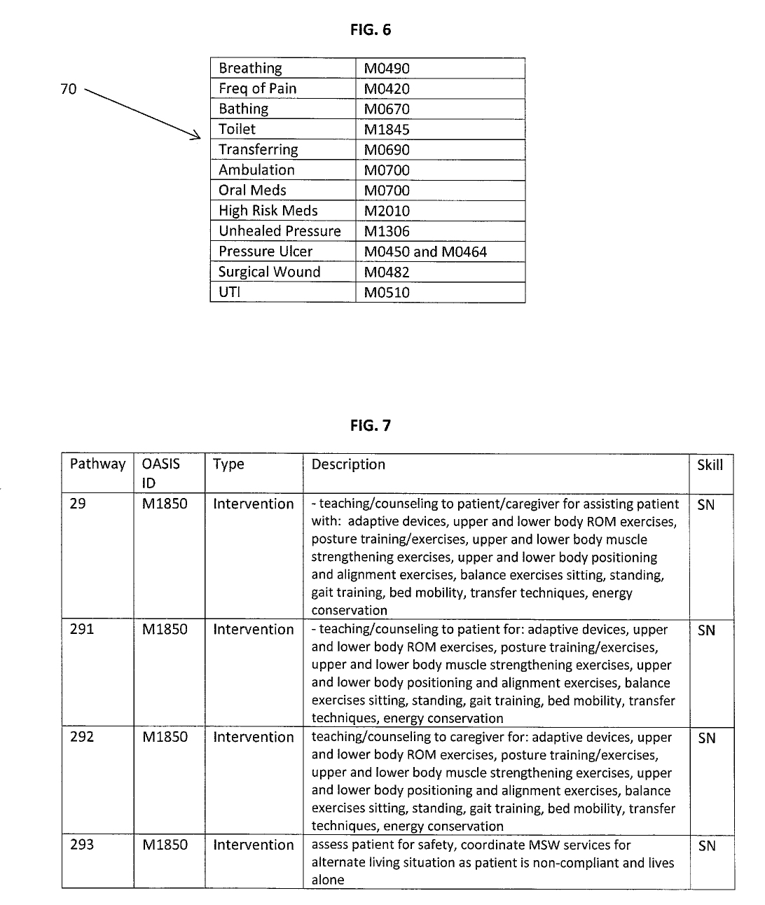

While all OASIS IDs are important, some weigh more heavily than others in determining the type of care that is necessary for the patient. Based on industry best practices, a subset of OASIS IDs has been assembled into a critical list 70, which requires additional processing. This list 70 may vary, depending on the current best practices. FIG. 6 illustrates an example critical list 70, showing the OASIS ID and “M” number. OASIS IDs that are not on the critical list have only one care plan, such as for M1700 shown in FIG. 3. If the ID containing the abnormal finding is not on the critical list 70, the care plan is added to the list of care plans for the patient at step S28.

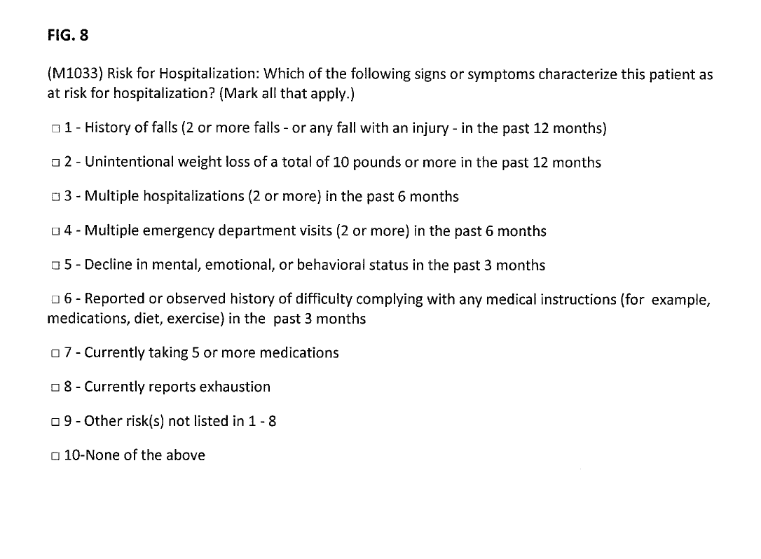

If the ID containing the abnormal finding is on the critical list, additional processing is carried out to determine the proper treatment. Specifically, two key factors must be checked at step S34 with each identifier in the critical list 70. The first factor is the indicator for “frailty”, which includes risk factors that indicate the patient may be hospitalized. In particular, the method checks to see if the “frailty” question indicates that the patient has had difficulty complying with any medical instructions (i.e., taking medications, following a certain diet, or exercising) in the past three months. FIG. 8 illustrates the current OASIS indicator for frailty, which is identified as M1033, and the report or observation that the patient has difficultly complying is indicated by the number “6”. The second factor is the level of assistance required to complete Activities Of Daily Living (ADL) S32/S36. OASIS has five levels of ADL assistance: 0 (No assistance ended); 1 (Non-agency caregivers available to provide assistance); 2 (Non-agency caregivers need training/supportive services to provide assistance); 3 (non-agency caregivers are not likely to provide assistance or it is unclear if they will provide assistance); 4 (assistance needed, but no non-agency caregivers are available). The software tests each of these indicators and then selects the appropriate care plan based on the OASIS data at steps S38, S42, S44, S46. In the current OASIS, ADL is identified as M2102(a) (not shown).

FIG. 7 illustrates an example set of care plans for patients who have an abnormal finding for the critical OASIS entry for “Transferring: current ability to move safely from bed to chair, or ability to turn and position self in bed if patient is bedfast”. If there is no risk of hospitalization and the patient is compliant, pathway 29 is chosen. If there is a risk of hospitalization and the patient is compliant, pathway 291 is chosen. If there is no risk of hospitalization but the patient is non-compliant, then pathway 292 is chosen. Finally, if there is a risk of hospitalization and the patient is not compliant pathway 293 is chosen. These examples only illustrate the intervention step, however, it is understood that each care plan may also involve additional teachings, goals, and/or additional intervention steps as illustrated in FIG. 3.

Step S5 calculates the patient's health score. For payment purposes, Medicare presently tracks the results of 41 of the OASIS questions. Those 41 questions fall into four categories: Five-Star; Value-based Purchasing, or VBP; Home Health COMPARE, or HHC; and Potentially Avoidable Events, or PAE. For each category, the software iterates over the set of OASIS data and calculates the average value of the data entry. A total average of the four category averages is then calculated and displayed to the practitioner. For example, in the current OASIS, M1700 (cognitive function) may have a value ranging from 0-4. If the current value is 2, which indicates that the patient requires assistance and some direction in specific situations, the score for this one data entry would be 2/4=0.5. Similarly, M1730 (depression screening) has a value ranging from 0-3. If the current value is 1, the score would be 1/3=0.33. If these two questions formed one of the groups, the group score would be (0.5+0.33)/2=0.415. If the score for the other three groups are, respectively, 0.8, 0.2 and 0.5, the total score that would be displayed to the practitioner is: (0.415+0.8+0.2+0.5)/4=0.48.

It is understood that the embodiments described herein are merely illustrative of the present invention. Variations in the method may be contemplated by one skilled in the art without limiting the intended scope of the invention herein disclosed and as defined by the following claims.

What is claimed is:

1: A computerized method of generating healthcare plans based on a set of questions from a patient assessment form, the method comprising the steps of:
a) providing the patient assessment form in electronic format;
b) presenting the set of questions to a practitioner via a user interface, the practitioner entering appropriate answers that constitute patient-specific assessment data;
c) providing a first database for storing the patient-specific assessment data;
d) providing a second database that contains a set of predefined care plans, each care plan in the set being associated with a diagnosis of a specific abnormal condition;
e) analyzing the patient-specific assessment data for one or more indicators of one or more abnormal conditions and, upon finding one or more indicators for abnormal conditions, associating each abnormal condition found with the specific one of the predefined care plans to create a patient-specific set of care plans; and
f) providing the set of patient-specific care plans to the practitioner.

2: The method of claim 1, wherein analyzing the patient-specific assessment data includes the steps of:
e1) upon finding an indicator for an abnormal condition analyzing the patient-specific assessment data for an indication that the abnormal condition is a critical condition;
e2) upon finding that the abnormal condition is not a critical condition, associating the abnormal condition found with the specific predefined care plan and adding the care plan to a patient-specific set of care plans;
e3) upon finding that the abnormal condition is a critical condition, analyzing the patient-specific assessment data for an indication that the patient is frail and for an indication of the amount of assistance with daily living activities that is required and associating the abnormal condition found with the specific predefined care plan and adding the care plan to the patient-specific set of care plans.

3: The method of claim 2 wherein the step of providing the patient assessment form in electronic format further includes the following:
a) providing the OASIS patient assessment form in electronic format.

4: The method of claim 3 further including the following step:
g) adding the abnormal condition data to an activity database.

5: The method of claim 4 wherein the step of providing the patient assessment form in electronic format further includes the following:
a1) determining whether the current patient visit is the initial patient visit;
a2) upon determining that the current visit is the first patient visit, providing the OASIS patient assessment form in electronic format;
a3) upon determining that the current patient visit is not the first patient visit, accessing the patient data in the activity table and providing the patient assessment form in electronic format for the conditions stored in the activity table.
